(19) United States
(12) Patent Application Publication
(10) Pub. No.: US 2016/0268852 A1
(43) Pub. Date: Sep. 15, 2016

(54) STATOR AND METHOD OF MANUFACTURING THE SAME

(71) Applicant: FANUC CORPORATION, Yamanashi (JP)

(72) Inventors: Koudai Akashi, Yamanashi (JP); Makoto Funakubo, Yamanashi (JP)

(73) Assignee: FANUC CORPORATION, Yamanashi (JP)

(21) Appl. No.: 15/063,979

(22) Filed: Mar. 8, 2016

(30) Foreign Application Priority Data
Mar. 11, 2015 (JP) 2015-048608

(51) Int. Cl. H02K 1/18; H02K 15/02

(52) U.S. Cl. CPC H02K 1/185; H02K 15/02

(57) ABSTRACT

A stator includes a stator core, a pair of housings arranged at either end of the stator core, a rod inserted into a through-hole formed in the stator core, and a bolt inserted into a through-hole of the housings and connected to a protrusion of the rod protruding from either end surface of the stator core to fasten the stator core and the housings. A sealing member formed of a sealant, which is expanded and hardened by heating, is arranged at least partially around the rod.

### BACKGROUND OF THE INVENTION

1. Field of the Invention

The present invention relates to a stator of an electric motor and a method of manufacturing the stator.

2. Description of the Related Art

The stator of an electric motor disclosed in Japanese Laid-open Patent Publication No. 2006-6054 includes a stator core and two housings arranged at either end of the stator core. A plurality of through-holes are formed in the vicinity of the circumferential surface of the stator core and are extended in the axial direction of the electric motor. Rods formed with threaded portions at both ends are inserted into the through-holes. Bolts are inserted into through-holes formed in the two housings and are screwed to the threaded portions of the rods, thereby fastening the stator core and the housings. Japanese Laid-open Patent Publication No. 2006-6054 discloses an electric motor having such a structure.

Incidentally, an electric motor requires airtightness and being liquid-proof. The stator core is formed of a stack of steel plates. Therefore, the through-holes formed in both the housing and the stator core provide communication between the internal space of the electric motor and a gap between the stacked steel plates. Hence, sealing is necessary around the through-holes.

### SUMMARY OF THE INVENTION

However, a sufficient sealing area may not be available between the through-holes formed in the stator core and the rods inserted into the through-holes. This is because the through-holes need to be formed in the vicinity of the outer circumference of the stator core in order to maintain insulation between coils wound around the stator core and the rods. Furthermore, securing a sealing area requires an increase in an outside diameter of the stator. However, in this case, the electric motor would have to be increased in size, and manufacturing costs would also increase.

A further alternative would be to apply sealant into the through-holes formed in the stator core so as to seal the through-holes. However, since the through-holes are axially elongate, it takes a great amount of time to perform application work for applying sealant across the entire interior of the through-holes. Furthermore, it is difficult to automate such work.

The present invention has been made in view of the aforementioned circumstances, and it is an object of the present invention to provide a stator that allows easy sealing of through-holes and a method of manufacturing the stator.

In order to achieve the aforementioned object, according to a first invention, there is provided a stator including a stator core, a pair of housings arranged at either end of the stator core, a rod inserted into a through-hole formed in the stator core, and a bolt inserted into a through-hole of the housings and connected to a protrusion of the rod protruding from either end surface of the stator core, thereby fastening the stator core and the housings, wherein a sealing member formed of a sealant, which is expanded and hardened by heating, is arranged at least partially around the rod.

According to a second invention, the sealing member according to the first invention is arranged around the protrusion of the rod.

According to a third invention, the sealing member according to the first invention is arranged between the through-hole of the stator core and the rod inserted into the through-hole.

According to a fourth invention, an electric motor including the stator according to any of the first to third inventions is provided.

According to a fifth invention, there is provided a method of manufacturing a stator, including steps of inserting a rod into a through-hole formed in a stator core, inserting a bolt into a through-hole formed in housings arranged at either end of the stator core, arranging a sealing member formed of sealant which is expanded and hardened by heating at least partially around the rod, connecting a protrusion of the rod and the bolt, thereby fastening the stator core and the housings, and expanding and hardening the sealing member by heating.

These and other objects, features and advantages of the present invention will be more apparent from the detailed description of typical embodiments of the present invention illustrated in the accompanying drawings.

### BRIEF DESCRIPTION OF THE DRAWINGS

FIG. 1 is an axially cross-sectional view of an electric motor including a stator according to the present invention.

FIG. 2 is a cross-sectional view of the stator of the electric motor illustrated in FIG. 1.

FIG. 3A is a partially enlarged view of a stator according to a first embodiment of the present invention.

FIG. 3B is another partially enlarged view of the stator according to the first embodiment of the present invention.

FIG. 4A is a partially enlarged view of a stator according to a second embodiment of the present invention.

FIG. 4B is another partially enlarge view of the stator according to the second embodiment of the present invention.

### DETAILED DESCRIPTION

In the following, embodiments of the present invention are described with reference to the accompanying drawings. In the following drawings, like parts are designated by like reference numerals. For the sake of easy understanding, the scales of the drawings are varied appropriately.

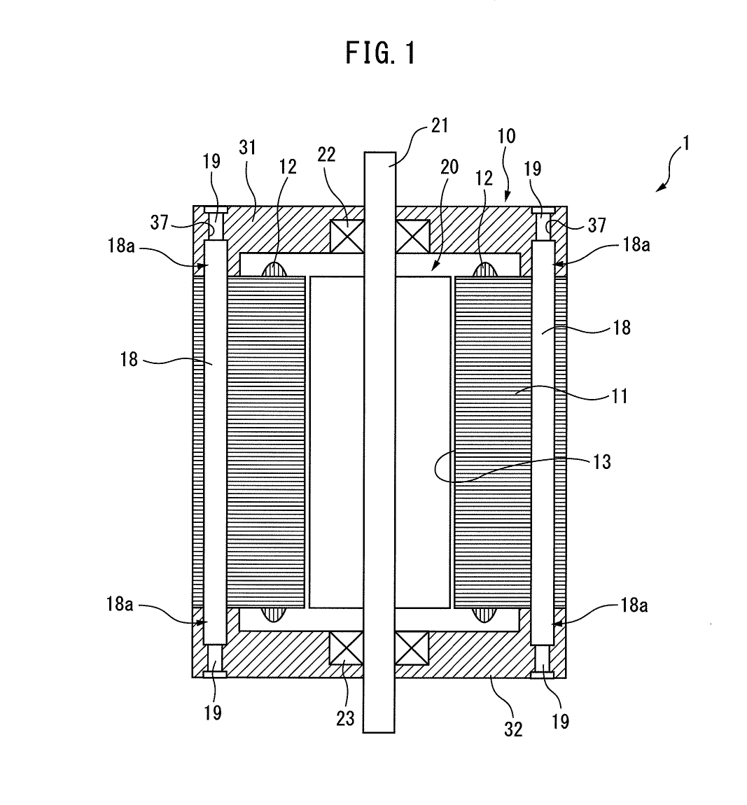

FIG. 1 is an axially cross-sectional view of an electric motor including a stator according to the present invention. As illustrated in FIG. 1, an electric motor 1 includes a stator 10 and a rotor 20 rotatably arranged in the stator 10.

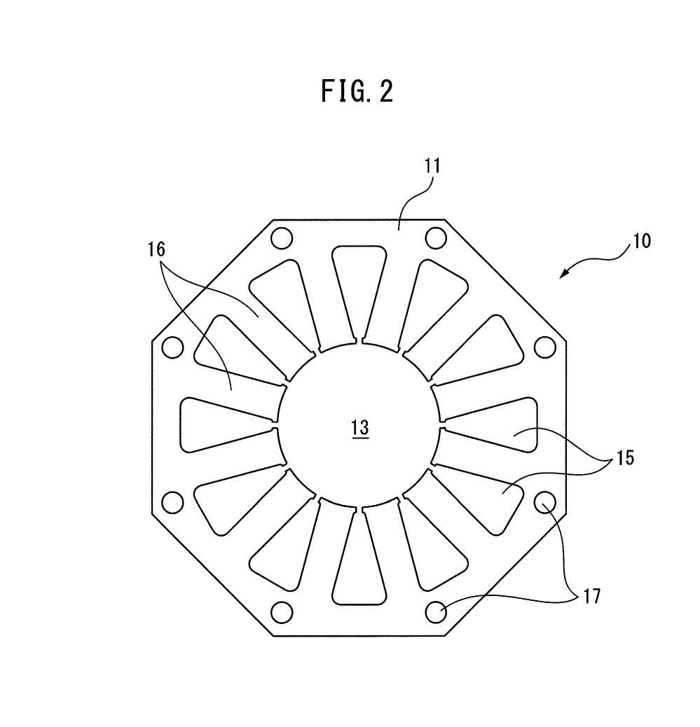

FIG. 2 is a cross-sectional view of the stator of the electric motor illustrated in FIG. 1. For the sake of simplicity, the rotor 20 and housings to be described below are not illustrated in FIG. 2. As can be seen from FIGS. 1 and 2, a stator core 11 of the stator 10 is formed of a stack of a plurality of octagonal magnetic steel plates.

As illustrated in FIG. 2, a plurality of, e.g., 12,slots 15 are formed on the inner circumferential surface of the stator 10 at regular intervals. Coils 12 (see FIG. 1) are wound via insulating papers around stator teeth 16 between the adjacent slots 15. Furthermore, a hollow hole 13 is formed at the center of the stator core 11.

As can be seen from FIG. 1, a first housing 31 and a second housing 32 are mounted on an upper end and a lower end of the stator core 11, respectively. The first housing 31 and the second housing 32 illustrated in FIG. 1 are members having a U-shaped cross-section. However, the first housing 31 and the second housing 32 may be lid-shaped members. In the present invention, the external shape of the electric motor 1 is defined by the stator core 11, the first housing 31, and the second housing 32 of the stator 10.

Central holes in which bearings 22, 23 are arranged are formed at the centers of the first housing 31 and the second housing 32, respectively. Furthermore, the bearings 22, 23 rotatably support a rotary shaft 21 of the rotor 20.

As illustrated in FIG. 2, through-holes 17 are formed at regular intervals in the circumferential direction on radially outer sides of the slots 15 of the stator core 11. Furthermore, as can be seen from FIG. 1, rods 18 are inserted into the respective through-holes 17. Both ends of the rods 18 are protrusions 18a protruding from the stator core 11. The protrusions 18a are formed with threaded portions, e.g., internally threaded portions.

Furthermore, the first housing 31 and the second housing 32 are formed with through-holes 37 corresponding to the through-holes 17 of the stator core 11. Bolts 19 are inserted into the through-holes 37 from the outside of the first housing 31 and the second housing 32 and are screwed to the threaded portions of the protrusions 18a. In this way, the first housing 31 and the second housing 32 are fastened to the stator core 11. The first housing 31 and the second housing 32 may be fastened to the stator core 11 in a different manner.

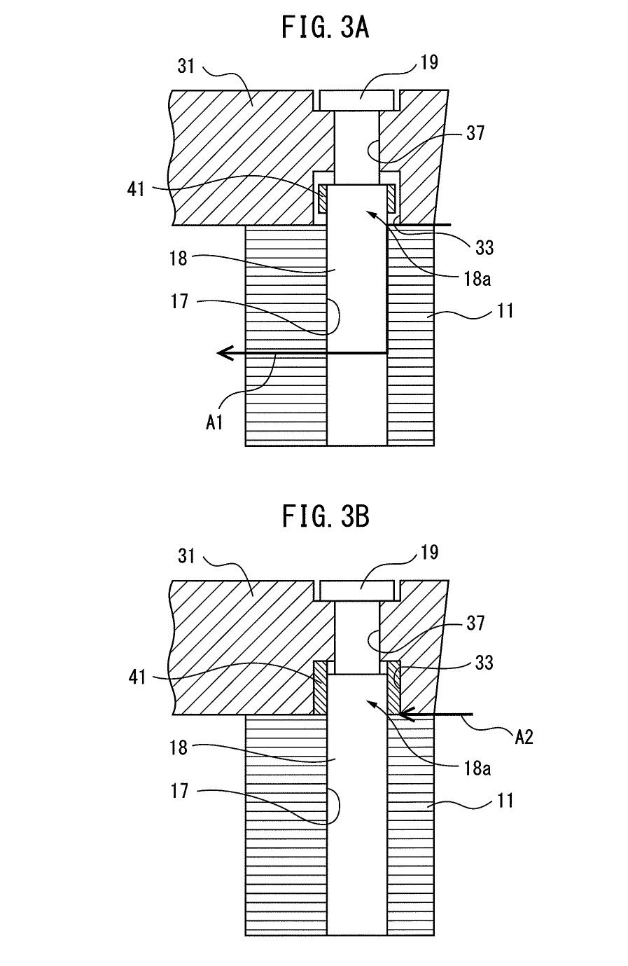

FIGS. 3A and 3B are partially enlarged views of the stator according to the first embodiment of the present invention. In the following, for the sake of simplicity, an area in the vicinity of the fastened portion between the first housing 31 and the stator core 11 is described. The same description applies to the fastened portion between the second housing 32 and the stator core 11. Furthermore, in the following drawings, for the sake of easy understanding, a lid-shaped first housing 31 is illustrated.

As illustrated in FIG. 3A, the connection surface of the first housing 31 facing the stator core 11 is formed with a recess 33. As illustrated, the recess 33 is dimensioned to accommodate the protrusion 18a of the rod 18. Furthermore, a sealing member 41 is arranged around the protrusion 18a. The sealing member 41 is formed of sealant which is expanded and hardened by heating. In FIG. 3A, a cylindrical sealing member 41 is illustrated.

As the sealant forming the sealing member 41, for example, a material including a thermosetting epoxy resin containing an expandable filler therein may be used. As the expandable filler, for example, a capsule may be used which uses resin or the like to encapsulate a material which is thermally decomposed, vaporized and expanded by heating or a liquid material which is vaporized by heating.

According to the present invention, after the rods 18 are inserted into the stator core 11, the sealing members 41 are attached to the protrusions 18a of the rods 18. Then, after the rotor 20 is arranged in the hollow hole 13, the first housing 31 and the second housing 32 are arranged at the either end of the stator core 11. Then, the bolts 19 are screwed to the protrusions 18a of the rods 18, thereby fastening the first housing 31 and the second housing 32 to the stator core 11. FIG. 3A partially illustrates the stator 10 and the electric motor 1 in such a state.

As described above, the stator core 11 is formed by stacking magnetic steel plates. Therefore, there can be a small gap between the adjacent magnetic steel plates. Thus, as is indicated by the arrow A1 in FIG. 3A, fluid, e.g., liquid, may enter through a gap between the first housing 31 and the stator core 11 from the outside of the electric motor 1 and travel along the through-hole 17. Then, the fluid can flow through a gap between the magnetic steel plates at a certain point of the stator core 11 and reach the hollow hole 13 and the rotor 20.

Therefore, in the present invention, after the sealing member 41 is arranged around the protrusion 18a, the electric motor 1 is generally heated. When the sealing member 41 is heated, the expandable filler is expanded, increasing the volume of the sealing member. In this way, as is illustrated in FIG. 3B, the sealing member 41 fills the entire recess 33 and is hardened in such a state.

Accordingly, as is indicated by the arrow A2 in FIG. 3B, even if fluid, e.g., liquid, enters from the outside of the electric motor 1, the flow of the fluid is stopped by the sealing member 41 in the recess 33. Thus, such fluid can be prevented from reaching the hollow hole 13 and the rotor 20. Furthermore, in the first embodiment, the sealing member 41 is arranged in the recess 33 of the first housing 31. Thus, a relatively small amount of sealing member 41 suffices.

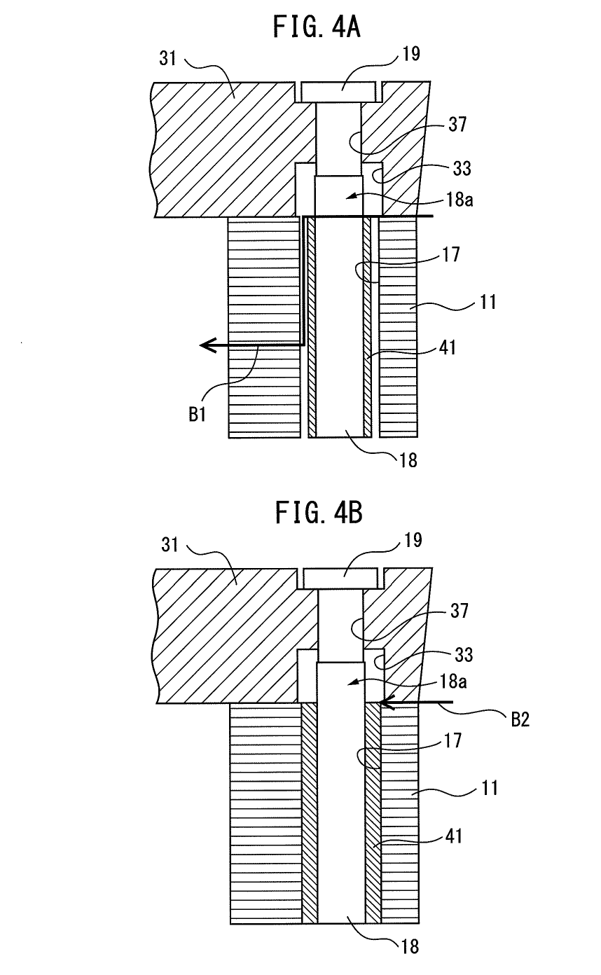

Furthermore, FIGS. 4A and 4B are partially enlarged views of the stator according to the second embodiment of the present invention. As can be seen from the drawings, the cross-sectional area of the through-hole 17 of the stator core 11 according to the second embodiment is greater than that according to the first embodiment. In the second embodiment, the sealing member 41 is a cylindrically rolled-up sheet-like member and is arranged to be wound around the rod 18 in the through-hole 17. The timing of arranging the sealing member 41 is the same as previously described.

In this case, as is indicated by the arrow B1 in FIG. 4A, fluid, e.g. liquid, may enter the recess 33 through a gap between the first housing 31 and the stator core 11 from the outside of the electric motor 1 and travel along the through-hole 17. Then, the fluid can flow through a gap between the magnetic steel plates at a certain point of the stator core 11 and reach the hollow hole 13 and the rotor 20.

In the second embodiment, similarly, after the sealing member 41 is arranged around the rod 18, the electric motor 1 is heated entirely. Thus, as illustrated in FIG. 4B, the sealing member 41 is expanded and hardened by heating, thereby filling a gap between the rod 18 and the through-hole 17. Thus, as is indicated by the arrow B2 in FIG. 4B, even if fluid, e.g., liquid, enters from the outside of the electric motor 1, the flow of the fluid is stopped by the sealing member 41 at an upper end of the through-hole 17. Therefore, it will be appreciated that the same effect as described above is obtained. Furthermore, in the second embodiment, the sealing member 41 is arranged entirely within the gap between the through-hole 17 and the rod 18. Therefore, the entire interior of the through-hole 17 can easily be sealed.

As described above, in the present invention, the sealing member 41 formed of sealant which is expanded and hardened by heating is simply arranged around the rod 18, so that sealing can easily be provided around the rod regardless of the position of the through-hole 17. Thus, the arrangement work of arranging the sealing member 41 between the protrusion 18a of the rod 18 or the rod 18 and the through-hole 17 can be automated.

Furthermore, in general, when the coil of the stator of the electric motor is impregnated with varnish, the coil or the like is heated. Accordingly, the heating operation for expanding and hardening the sealing member 41 can be combined with the coil heating operation. Thus, it may not be necessary to separately provide a process for heating the sealing member 41 only. Therefore, the highly sealed stator 10 and electric motor 1 can be provided without the need of additional equipment or time.

### EFFECTS OF THE INVENTION

In the first and fifth inventions, the sealing member formed of sealant which is expanded and hardened by heating is simply arranged around the rod, so that sealing can easily be provided between the through-hole and the rod. Thus, such work can easily be automated.

In the second invention, the amount of sealant can be reduced.

In the third invention, the entire interior of the through-hole can easily be sealed.

In the fourth invention, the highly sealed electric motor can be provided.

The present invention has been described in connection with typical embodiments. However, those skilled in the art would appreciate that the above-specified modifications and other modifications, omissions, and additions can be made without departing from the scope of the present invention.

1. A stator comprising:
a stator core;
a pair of housings arranged at either end of the stator core;
a rod inserted into a through-hole formed in the stator core; and
a bolt inserted into a through-hole of the housings and connected to a protrusion of the rod protruding from either end surface of the stator core to fasten the stator core and the housings,
wherein
a sealing member formed of a sealant, which is expanded and hardened by heating, is arranged at least partially around the rod.

2. The stator according to claim 1, wherein the sealing member is arranged around the protrusion of the rod.

3. The stator according to claim 1, wherein the sealing member is arranged between the through-hole of the stator core and the rod inserted into the through-hole.

4. An electric motor comprising the stator according to claim 1.

5. A method of manufacturing a stator, comprising steps of:
inserting a rod into a through-hole formed in a stator core;
arranging a sealing member formed of sealant which is expanded and hardened by heating at least partially around the rod;
inserting a bolt into a through-hole formed in housings arranged at either end of the stator core;
connecting a protrusion of the rod and the bolt to fasten the stator core and the housings; and
expanding and hardening the sealing member by heating.
